(19) United States
(12) Patent Application Publication
(10) Pub. No.: US 2013/0306229 A1
(43) Pub. Date: Nov. 21, 2013

(54) PROCESSING METHOD OF METAL-GLASS COMPOSITE MATERIAL AND PROCESSING SYSTEM USING THE SAME

(71) Applicant: ASUSTEK COMPUTER INC., Taipei (TW)

(72) Inventors: Fei-Lin YANG, Taipei (TW); Yang-Po CHIU, Taipei (TW); Hung-Yuan WANG, Taipei (TW)

(21) Appl. No.: 13/891,850

(22) Filed: May 10, 2013

Related U.S. Application Data
(60) Provisional application No. 61/648,474, filed on May 17, 2012.

(30) Foreign Application Priority Data
Mar. 27, 2013 (TW) 102110955

(51) Int. Cl. B32B 38/00

(52) U.S. Cl. CPC B32B 38/0012
USPC 156/224; 156/443

(57) ABSTRACT

A manufacturing method of metal-glass composite material is disclosed. The manufacturing method of the metal-glass composite material includes following steps: coating one surface of a glass plate with an adhesive material; placing a metal plate and the glass plate in a press mold, wherein the surface of the glass plate with the adhesive material corresponds to the metal plate; and pressing the glass plate and the metal plate by the hot-press mold to make them attach to each other. A manufacturing system of the metal-glass composite material is also provided.

### CROSS-REFERENCE TO RELATED APPLICATION

This application claims the priority benefit of U.S. provisional application Ser. No. 61/648,474, filed on May 17, 2012, and Taiwan application serial no. 102110955, filed on Mar. 27, 2013. The entirety of the above-mentioned patent applications are hereby incorporated by reference herein and made a part of specification.

### BACKGROUND OF THE INVENTION

1. Field of the Invention

The invention relates to a metal-glass composite material and, more particularly, to a manufacturing method of a metal-glass composite material and a system using the same.

2. Description of the Related Art

A conventional composite material includes two or more materials which are attached to each. other via an adhesive material.

Conventionally, high polymer material or metal is usually used as a base material and is combined with different fiber materials to form the composite material. The composite material has composite features of the two materials, but the two materials cannot keep their unique features after being combined with each other. In order to make metal and glass keep their unique features, they are inserted into each other via iron casting, which can only be applied to a small part of metals (such as iron).

### BRIEF SUMMARY OF THE INVENTION

A manufacturing method of a metal-glass composite material includes following steps: coating one surface of a glass plate with an adhesive material; placing a metal plate and the glass plate in a hot-press mold, wherein the surface of the glass plate with the adhesive material corresponds to the metal plate; and pressing the glass plate and the metal plate by the hot-press mold to make the glass plate and the metal plate attach to each other.

A manufacturing system of a metal-glass composite material includes a coating device and a hot-press mold. The coating device coats one surface of a glass plate with an adhesive material. A metal plate and the glass plate are placed in the hot-press mold, and the surface of the glass plate with the adhesive material corresponds to the metal plate. The hot-press mold presses the glass plate and the metal plate to make the glass plate and the metal plate attach to each other via the adhesive material.

These and other features, aspects and advantages of the present invention will become better understood with regard to the following description, appended claims, and accompanying drawings.

### BRIEF DESCRIPTION OF THE DRAWINGS

FIG. 1 is a flow chart showing a manufacturing method of a metal-glass composite material in a first embodiment;

FIG. 2 is a schematic diagram showing a manufacturing system for manufacturing a metal-glass composite material in a first embodiment;

FIG. 3A is a schematic diagram showing a hot-press device in FIG. 2;

FIG. 3B is a schematic diagram showing the glass plate and the metal plate in FIG. 3A after they are pressed and shaped;

FIG. 4 is a sectional diagram showing glass, an adhesive material and a metal in FIG. 2; and

FIG. 5 is a flow chart showing a manufacturing method of a metal-glass composite material in a second embodiment.

### DETAILED DESCRIPTION OF THE EMBODIMENTS

A manufacturing method of a metal-glass composite material and a system using the same are illustrated with relating figures, and the same symbols denote the same components.

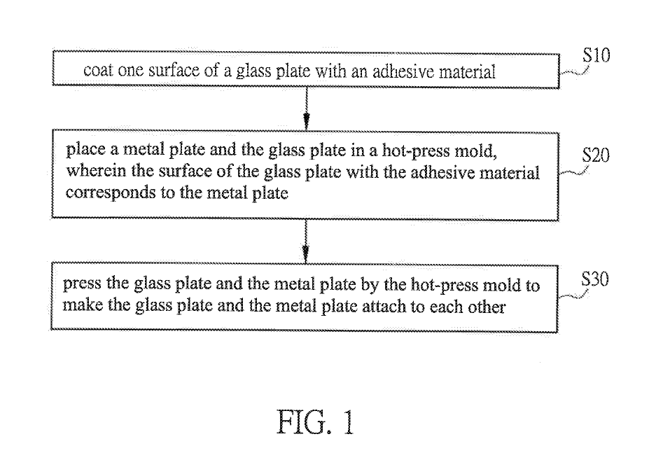

FIG. 1 is a flow chart showing a manufacturing method of a metal-glass composite material in a first embodiment. Please refer to FIG. 1, the manufacturing method of the metal-glass composite material includes following steps: coating one surface of a glass plate with an adhesive material (S10); placing a metal plate and the glass plate in a hot-press mold, wherein the surface of the glass plate with the adhesive material corresponds to the metal plate (S20); and pressing the glass plate and the metal plate by the hot-press mold to make the glass plate and the metal plate attach to each other (S30).

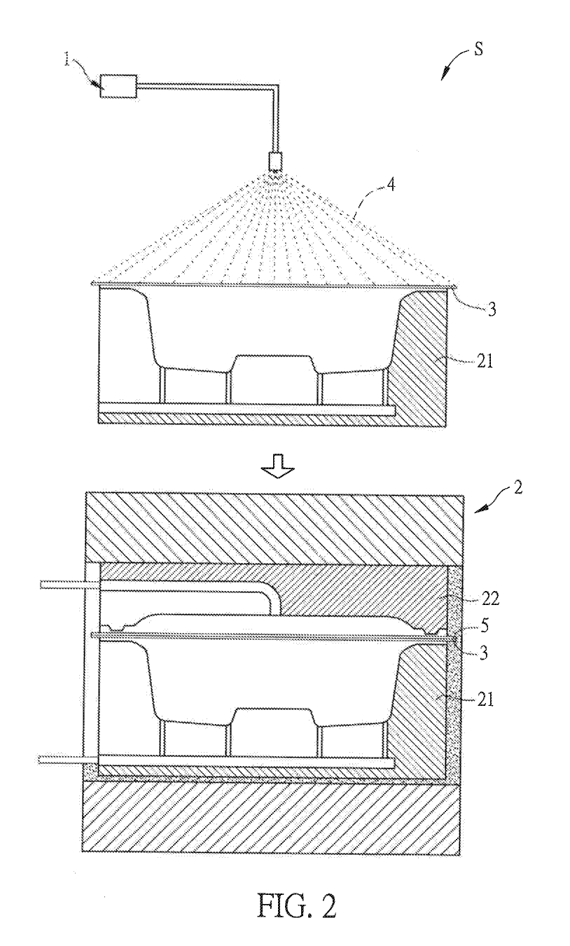

FIG. 2 is a schematic diagram showing a manufacturing system of a metal-glass composite material in a first embodiment. Please refer to FIG. 1 and FIG. 2, the manufacturing system S of the metal-glass composite material includes a coating device 1 and a hot-press mold 2. The coating device 1 may be a spraying device, a powder spraying and baking device, a soaking device or a transfer device, which is not limited herein. In step S10, the coating device 1 coats one surface of the glass plate 3 with the adhesive material 4. The glass plate 3 may he physically or chemically strengthened, such as soda potash glass or silicon glass.

The adhesive material 4 is primer containing silicon. Conventional primer is mainly used as a precursor of a first coating of building materials, which resists water or makes the material dyed more easily. The primer in the embodiment includes all kinds of coatings as long as they can be used as a precursor and they contain silicon. For example, the adhesive material 4 may be one or a combination of silicone resin, silicone resin monomer and glaze, especially the low temperature glaze (the low temperature glaze means the glaze which can be used under 550° C., such as low temperature lead glaze and non-lead glaze).

If the silicone resin or the silicone resin monomer is used as the adhesive material 4, the coating device 1 coats the glass plate 3 with the adhesive material 4 via the spraying device or the soaking device. If the adhesive material 4 is the glaze, one surface of the glass plate 3 is coated with the glaze by spraying, soaking, transferring, transfer printing or powder spraying and baking. As shown in FIG. 2, in the embodiment, the glass plate 3 is coated with the adhesive material 4 by spraying, which is not limited herein.

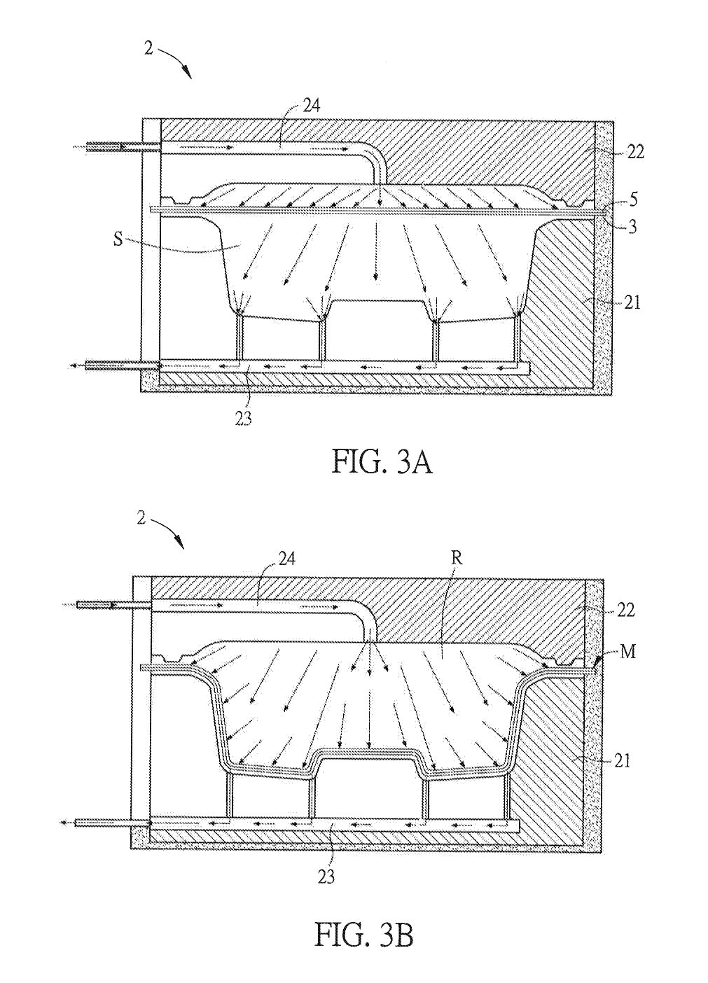

Moreover, the hot-press mold 2 may be a super plastic processing mold or a molding mold, and a super plastic processing mold is taken as an example in the embodiment, which is not limited herein. FIG. 3A is a schematic diagram showing a hot-press device in FIG. 2. Please refer to FIG. 1 and FIG. 3A, the hot-press mold 2 includes a first mold 21 and a second mold 22. The first mold 21 includes a pre-shaped mold for the metal-glass composite material and is connected to an exhaust passage 23.

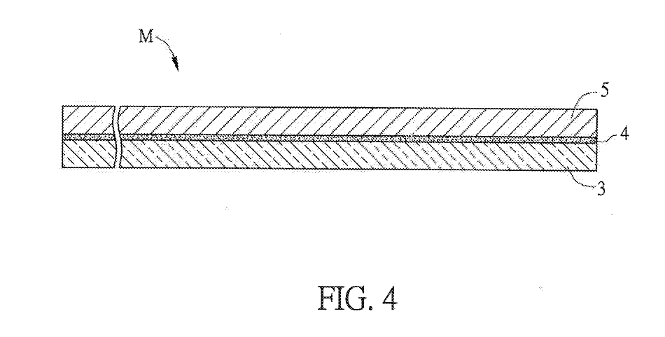

In step S20, the metal plate 5 and the glass plate 3 with the adhesive material 4 are placed in the first mold 21 of the hot-press mold 2, wherein the surface of the glass plate 3 with the adhesive material 4 corresponds to the metal plate 5. FIG. 4 is a sectional diagram showing the glass, the adhesive material and the metal in FIG. 2. In other words, the adhesive material 4 is between the glass plate 3 and the metal plate 5. The second mold 22 is disposed corresponding to the glass plate 3 and the metal plate 5, which means the glass plate 3 and the metal plate 5 are placed between the first mold 21 and the second mold 22. The metal plate 5 may be iron, titanium, aluminum, stainless steel or alloy, which is not limited herein.

In step S30, the hot-press mold 2 presses the glass plate 3 and the metal plate 5 to make them attached to each other. FIG. 3B is a schematic diagram showing the glass plate and the metal plate in FIG. 3A after they are pressed and shaped.

The first mold 21 and the second mold 22 are combined to form a sealing structure. The hot-press mold 2 further includes an inlet passage 24 connected to the second mold 22. As shown by arrows in FIG. 2, air flows into the hot-press mold 2 through the inlet passage 24 and presses the glass plate 3 and the metal plate 5. At the same time, the exhaust passage 23 connected to the first mold 21 exhausts the air to form vacuum space between the glass plate 3 and the first mold 21 to provide a pressing force to press the glass plate 3 and the metal plate 5 towards the first mold 21.

The pressing air flows through the inlet passage 24 to make the glass plate 3 and the metal plate 5 attached to each other and form the metal-glass composite material M. The exhaust passage 23 exhausts the pressing air to shape the metal-glass composite material M. Thus, since the adhesive material 4 contains silicon and can be used as a coating of a precursor (such as the silicone resin or the glaze), when the temperature and the pressure is increased, the glass plate 3 and the metal plate 5 are combined via the adhesive material 4 to form the metal-glass composite material M without glue.

As shown in FIG. 3A and FIG. 3B, the first mold 21 is pre-shaped into a specific shape for the metal-glass composite material M. When the glass plate 3 and the metal plate 5 are attached to each other via the adhesive material 4, they are shaped into the specific shape of the first mold 21. Additionally, before the glass plate 3 and the metal plate 5 are pressed by the hot-press mold 2, the temperature in the hot-press mold 2 increases and maintains between 300° C. to 500° C., so as to soften the glass plate 3 and the metal plate 5 and make them shaped as the specific shape of the first mold 21. The temperature in the hot-press mold 2 is determined according to a melting point of the metal plate 5, and it is better to increase the temperature above half of the melting point. For example, the melting point of aluminum is 660° C., and the temperature in the hot-press mold 2 increases to above 330° C. Thus, the metal plate 5 is half molten and the glass plate 3 is also softened, and it is easy to press and process the glass plate 3 and the metal plate 5.

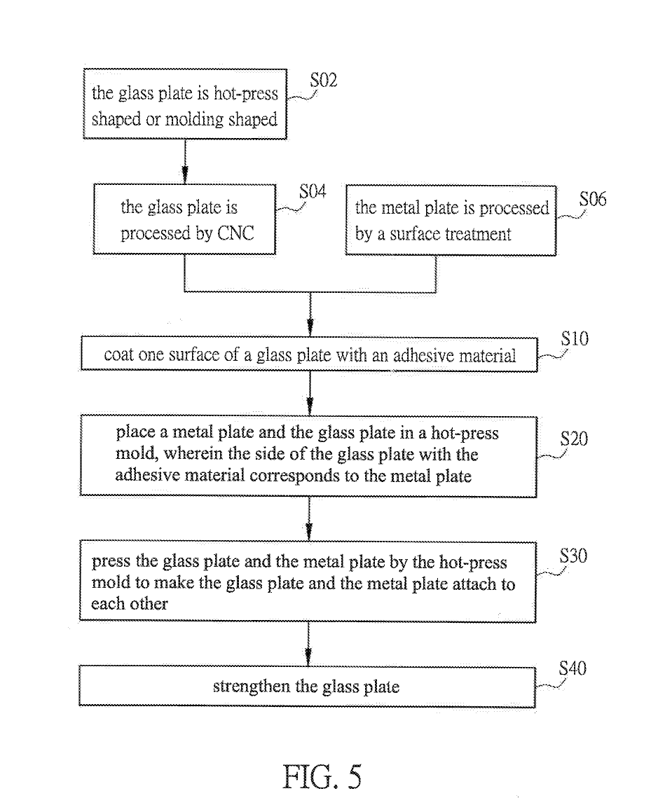

FIG. 5 is a flow chart showing a manufacturing method of a metal-glass composite material in a second embodiment. Please refer to FIG. 5, before the step S10 and one surface of the glass plate 3 is coated with the adhesive material 4, the glass plate 3 is hot-press shaped or molding shaped in step S02, which means the glass plate 3 is hot-press shaped or molding shaped first to form a plate, which is not limited herein. Thus, the glass plate 3 further includes flat glass which is hot-press shaped or molding shaped. After the glass plate 3 is formed, the glass plate 3 is processed by the computer numerical control (CNC) to form small structures (such as various patterns) in step S04. Then, the step S10 is executed. Thus, after the glass plate 3 and the metal plate 5 are pressed together, new patterns can be presented at the surface of the metal plate 5 by CNC processing at the surface of the glass plate 3.

Before the steps S10, the metal plate 5 may be processed by a surface treatment in step S06. The surface treatment includes electrical .discharge machining (EDM) surface treatment, plasma surface treatment, parkerizing, hot processing and micro-arc oxidation, which is not limited herein. Thus, the metal plate 5 includes a metal plate which is processed by the surface treatment.

As shown in FIG. 5, after the glass plate 3 is processed in the step S02 and the step S04 and the metal plate 5 is processed by the surface treatment in the step S06, the manufacturing system S executes main processing steps for the metal-glass composite material and makes the glass plate 3 and the metal plate 5 attached to each other to form the metal-glass composite material M in steps S10 to S30. After the metal-glass composite material M cools down, the glass plate 3 is strengthened in step S40. The metal-glass composite material M may be soaked in a soaking device which contains chemical strengthening liquid to strengthen the glass plate 3.

In sum, according to the manufacturing method of the metal-glass composite material and the manufacturing system in embodiments, it coats one surface of the glass plate with the adhesive material, wherein the surface corresponds to the metal plate, which means the adhesive material is between the glass plate and the metal plate. Since the adhesive material 4 contains silicon and can be used as a coating of a precursor (such as the silicone resin or the glaze), when the temperature and the pressure is increased, the glass plate 3 and the metal plate 5 are combined via the adhesive material 4. The hot-press mold increases temperature and pressure, and the pressing air flows in through the inlet passage to make the glass plate and the metal plate attached to each other to form the metal-glass composite material. The exhaust passage exhausts the pressing air and forms vacuum space between the first mold and the glass plate, so the metal-glass composite material is pressed and shaped. A bonding between the metal and the glass of the metal-glass composite material is larger than that in a conventional composite material.

Moreover, the glass plate may be processed via CNC and the metal plate may go through a surface treatment of anti-oxidation first. Thus, after the glass plate and the metal plate are combined, the surface of the metal plate presents new patterns by the CNC processing of the glass plate, and the composite material formed by the metal plate and the glass plate can directly be applied to a casing of an electronic device or other structures.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A manufacturing method of a metal-glass composite material comprising following steps:
coating one surface of a glass plate with an adhesive material;
placing a metal plate and the glass plate in a hot-press mold, wherein the surface of the glass plate with the adhesive material corresponds to the metal plate; and
pressing the glass plate and the metal plate by the hot-press mold to make the glass plate and the metal plate attach to each other.

2. The manufacturing method of the metal-glass composite material according to claim 1, wherein before the surface of the glass plate is coated with the adhesive material, the glass plate is hot-press shaped or is molding shaped.

3. The manufacturing method of the metal-glass composite material according to claim 1, wherein before the surface of the glass plate is coated with the adhesive material, the metal plate is processed by a surface treatment.

4. The manufacturing method of the metal-glass composite material according to claim 3, wherein the surface treatment includes electrical discharge machining (EDM) surface treatment and plasma surface treatment.

5. The manufacturing method of the metal-glass composite material according to claim 1, wherein the adhesive material includes one or a combination of silicone resin, silicone resin monomer and glaze.

6. A manufacturing system of a metal-glass composite material comprising:
a coating device coating one surface of a glass plate with an adhesive material; and
a hot-press mold, wherein a metal plate and the glass plate are placed in the hot-press mold, the surface of the glass plate with the adhesive material corresponds to the metal plate, and the hot-press mold presses the glass plate and the metal plate to make the glass plate and the metal plate attach to each other via the adhesive material.

7. The manufacturing system of the metal-glass composite material according to claim 6, wherein the glass plate includes flat glass which is hot-press shaped or molding shaped.

8. The manufacturing system of the metal-glass composite material according to claim 6, wherein the metal plate includes a metal plate which is processed by a surface treatment.

9. The manufacturing system of the metal-glass composite material according to claim 6, wherein the hot-press mold includes a superplastic mold or a molding mold.

10. The manufacturing system of the metal-glass composite material according to claim 6, wherein the adhesive material includes one or a combination of silicone resin, silicone resin monomer and glaze.
